(19) United States
(12) Patent Application Publication
(10) Pub. No.: US 2012/0150850 A1
(43) Pub. Date: Jun. 14, 2012

(54) SEARCH RESULT RELEVANCE BY DETERMINING QUERY INTENT

(75) Inventors: SASI PARTHASARATHY, Seattle, WA (US); Maksym Rogov, Kirkland, WA (US); Andrey Zaytsev, Sammamish, WA (US)

(73) Assignee: MICROSOFT CORPORATION, REDMOND, WA (US)

(21) Appl. No.: 12/963,186

(22) Filed: Dec. 8, 2010

(51) Int. Cl. G06F 17/30

(52) U.S. Cl. 707/728; 707/E17.014

(57) ABSTRACT

Embodiments of the present invention relate to systems, methods, and computer-storage media for determining search query intent based on search results retrieved in response to a search query. In one embodiment, a plurality of search results that are responsive to a search query are retrieved. The plurality of search results is ranked based on relevance to the search query. Additionally, an adult-content score is assigned to one or more of the plurality of search results based on categorizing an amount of adult content within each of the one or more plurality of search results. Further, a search-query-intent score is determined based on the adult-content score of each of the one or more plurality of search results and the ranking of each of the one or more plurality of search results.

### BACKGROUND

Companies that provide adult content have a strong interest in having their websites returned in response to search queries. However, companies that manage search engines try to keep adult content from being presented to users that are not interested in receiving adult content. In particular, companies that host search engines want to keep websites that host adult content from being presented as search results in response to a general user query. As such, companies that provide adult content continually work to generate new strategies to evade efforts of search engines to block presentation of search results associated with adult content. Accordingly, companies that host search engines must develop evolving methods of identifying and blocking websites having adult content from being presented within search results retrieved in response to a search query.

### SUMMARY

This Summary is provided to introduce a selection of concepts in a simplified form that are further described below in the Detailed Description. This Summary is not intended to identify essential features of the claimed subject matter, nor is it intended to be used as an aid in isolation to determine the scope of the claimed subject matter. Embodiments of the present invention provide methods for determining query intent. In particular, methods are provided for determining query intent by analyzing the search query and the search results. For example, when determining whether a search query is intended to produce adult content, the search query may be analyzed to determine whether the search query is associated with adult content. However, websites that host adult content may continually associate their websites with innocuous terms, such as “sunscreen” or “coffee mug” in order to present their content to a wider audience. As such, the terms “sunscreen” and “coffee mug” may not be associated with adult content when categorizing a search query. Accordingly, the search results that are produced from the search query may be analyzed. In particular, the search results may be ranked accordingly to relevance to the search query. By analyzing the search query results for adult content, a determination may be made as to whether the search query is intended to produce adult content. Further, a determination of a search query intent may be based on a safety setting associated with the search query. For example, a safety setting may be strict, moderate, or off. Accordingly, the determination of a search query intent may be influenced by a safety setting associated with the search query.

### BRIEF DESCRIPTION OF THE DRAWINGS

Embodiments of the invention are described in detail below with reference to the attached drawing figures, wherein:

FIG. 1 is a block diagram illustrating an exemplary computing device suitable for use in connection with embodiments of the present invention;

FIG. 2 is a schematic diagram illustrating an exemplary system for determining search query intent based on search results retrieved in response to receiving a search query, in accordance with an embodiment of the present invention;

FIG. 3A is a schematic diagram that illustrates an assessment of search results based on adult-content scores, in accordance with an embodiment of the present invention;

FIG. 3B is a schematic diagram that illustrates a determination of search results based on adult-content scores, in accordance with an embodiment of the present invention;

FIG. 4A is a schematic diagram that illustrates an assessment of search results based on weighted adult-content scores, in accordance with an embodiment of the present invention;

FIG. 4B is a schematic diagram that illustrates a determination of search results to be provided in response to a search query based on weighted adult-content scores, in accordance with an embodiment of the present invention;

FIG. 5A is a schematic diagram that illustrates an assessment of search results to be provided in response to a search query based on weighted commercial scores, in accordance with an embodiment of the present invention;

FIG. 5B is a schematic diagram that illustrates a determination of search results to be provided in response to a search query based on weighted commercial scores, in accordance with an embodiment of the present invention;

FIG. 6 is a process flow diagram illustrating a method of determining search query intent based on search results retrieved in response to receiving a search query, in accordance with an embodiment of the present invention;

FIG. 7 is a flow diagram illustrating a method of determining search query intent based on search results retrieved in response to receiving a search query, in accordance with an embodiment of the present invention;

FIG. 8 is another flow diagram illustrating a method of determining search query intent based on search results retrieved in response to receiving a search query, in accordance with an embodiment of the present invention; and

FIG. 9 is a further flow diagram illustrating a method of determining search query intent based on search results retrieved in response to receiving a search query, in accordance with an embodiment of the present invention.

### DETAILED DESCRIPTION

The subject matter of embodiments of the invention disclosed herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide methods for determining query intent. In particular, methods are provided for determining query intent by analyzing search results responsive to a search query. Each search result may be categorized based on adult content within the search results. For example, each search result may be given a binary document category indicating that each result does or does not contain adult content. When retrieving a document, metadata may already be attached to the document indicating that the document has adult content, is on a blocked list, or is otherwise undesirable based on a safety setting associated with the search query. Further, each document may have two or more metadata categories associated with the document. In addition to classifying documents based on adult content, embodiments of the present invention may also be used to classify documents into other categories, such as commercial or informational intent. As with adult content, metadata may also be used to identify documents as being related to commercialization, information, or both. The metadata may be generated by an automated analysis of the documents and stored in an index in a manner that allows that metadata to be associated with individual documents. The metadata may be based on feedback or input from one or more people.

Categorization of adult content within search results may also be based on the presence of keywords within the search results, context of the search results, or a combination of both. Additionally, the categorization of adult content may be based on the probability that each search result contains adult content based on website affiliations, advertisements, and other factors. Further, a search-query-intent score may be determined based on the adult-content scores assigned to the search results. A search-query-intent score may be based on individual assessments of a plurality of search results returned in response to a search query. Alternatively, a search-query-intent score may be based on a cumulative assessment of the plurality of search results.

A search-query-intent score may be determined for a query based on assessing search results returned in response to the query. In one embodiment, a random selection of search results, which are selected from a plurality of search results returned in response to a search query, are used to determine the search-query-intent score. In another embodiment, a plurality of search results with a high relevance ranking are used to determine the search-query-intent score. The search results may be ranked using a ranking component that ranks each search result based on relevance of each search result to the search query. The ranking component may assess each search result independent of attached metadata that may otherwise compromise a ranking of a search result based on a former classification (e.g., as adult, blocked, commercial, informational, etc.). In this way, the ranking component may objectively determine which search results have the greatest relevance and, accordingly, would likely be returned as a top result in response to a search query.

Once the search results have been ranked, a discrete number of search results may be analyzed based on their ranking. For example, the top ten search results may be assessed based on categorization of adult content as discussed above. Further, the adult-content scores of each of the top ten search results may be weighed by based on the position of each search result within the ranking of search results. In one embodiment, results with a high relevance rank receive more weight than results with a low relevance rank. Accordingly, the weighted adult content scores may be used to determine a search-query intent score for the plurality of search results.

As discussed above, the determination of a search-query-intent score may be based on a safety setting associated with the search query. Additionally, the search-query-intent score may be used to influence the search results presented to a user in response to a search query. In fact, if a search-query-intent score reflects that a high proportion of search results are associated with adult content, the user may be presented with a blank page responsive to the search query. Alternatively, if a search-query-intent score reflects that a high proportion of search results are associated with adult content, the user may be presented with a generic search result, such as an encyclopedia entry, that explains the definition of a query term without actually providing adult content to the user. Further, if a search-query-intent score reflects that a low proportion of search results are associated with adult content, the user may be presented with all of the search results if the safety settings associated with the search query are set to low. However, if the safety settings associated with the search query are set to strict, then the search query may not return any results if even one search result is associated with adult content. For example, under a strict setting, any search results associated with adult content may indicate that other search results associated with the search query may also be associated with adult content. Alternatively, even if the safety settings associated with the search query are set to strict, the user may be presented with filtered results that are known to be non-adult if the overall proportion of search results is below a low threshold.

Accordingly, in one embodiment, the present invention provides computer-storage media having computer-executable instructions embodied thereon that, when executed, perform a method of determining search query intent based on search results retrieved in response to receiving a search query. The method comprises retrieving a plurality of search results that are responsive to a search query. The method also comprises ranking the plurality of search results based on relevance to the search query. Additionally, the method comprises assigning an adult-content score to one or more of the plurality of search results. Each adult-content score is based on an amount of adult content within each of the one or more plurality of search results. Further, the method comprises determining a search-query-intent score. The search-query-intent score is based on the adult-content score of each of the one or more plurality of search results and the ranking of each of the one or more plurality of search results

In another embodiment, the present invention provides computer-storage media having computer-executable instructions embodied thereon that, when executed, perform a method of determining search query intent based on search results retrieved in response to receiving a search query. The method comprises receiving a search query. Additionally, the method comprises assigning a query-intent score to the search query. The query-intent score may be based on categorizing the search query according to intent to retrieve a document within a subject-matter category. The method also comprises retrieving a plurality of search results that are responsive to the search query. Further, a subject-matter score may be assigned to one or more of the plurality of search results. The subject-matter score may be based on content within each of the one or more plurality of search results that falls into the subject-matter category. Additionally, a search-query-intent score may be determined based on the query-intent score of the search query and the subject-matter score of each of the one or more plurality of search results.

In a further embodiment, the present invention provides computer-storage media having computer-executable instructions embodied thereon that, when executed, perform a method of determining search query intent based on search results retrieved in response to receiving a search query. The method comprises receiving a search query. The method also comprises assigning a query-intent score to the search query based on an analysis of the search query that indicates whether the search query is intended to return results with adult content. Additionally, the method comprises retrieving a plurality of search results that are responsive to a search query. Further, the plurality of search results is ranked based on relevance to the search query. An adult-content score is assigned to one or more of the plurality of search results by categorizing each of the one or more plurality of search results based on characteristics that are consistent with adult content within each of the one or more plurality of search results. The method also comprises determining a search-query-intent score based on the query-intent score of the search query, the adult-content score of each of the one or more plurality of search results, and the ranking of each of the one or more plurality of search results. Additionally, the method comprises determining that the search-query-intent score meets a threshold safety score. The method also comprises presenting a page to the user in response to receiving the search query based on the search-query-intent score meeting the threshold safety score.

Various aspects of embodiments of the invention may be described in the general context of computer program products that include computer code or machine-usable instructions, including computer-executable instructions such as applications and program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including dedicated servers, general-purpose computers, laptops, more specialty computing devices, and the like. The invention may also be practiced in distributed computing environments where tasks are performed by remote-processing devices that are linked through a communications network.

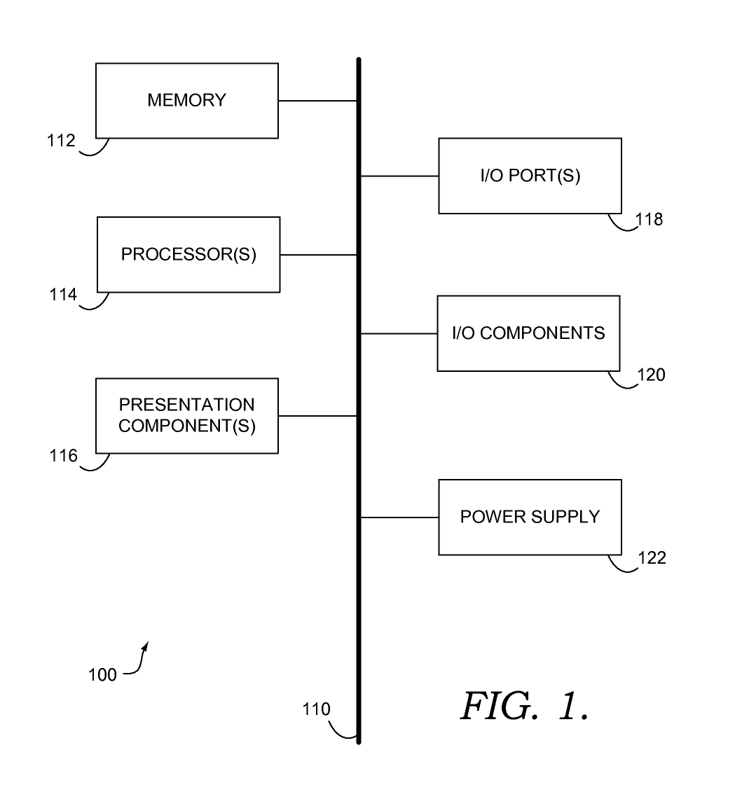

An exemplary operating environment in which various aspects of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of components illustrated.

Computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” “mobile device,” “PDA,” “smart phone” etc., as all are contemplated within the scope of FIG. 1 and reference to “computing device.”

Additionally, computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer-storage media and communication media. Computer-storage media includes both volatile and nonvolatile, removable and non-removable media implemented in any method or technology for storage of information such as computer-readable instructions, data structures, program modules or other data.

Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Computer-storage media are non-transitory. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-executable instructions 113 stored in volatile and/or nonvolatile memory. The memory may be removable, nonremovable, or a combination thereof. Exemplary hardware devices include solid-state memory, hard drives, optical-disc drives, etc. Computing device 100 includes one or more processors 114 coupled with system bus 110 that read data from various entities such as memory 112 or I/O components 120. In an embodiment, the one or more processors 114 execute the computer-executable instructions 113 to perform various tasks and methods defined by the computer-executable instructions 115. Presentation component(s) 116 are coupled to system bus 110 and present data indications to a user or other device. Exemplary presentation components 116 include a display device, speaker, printing component, etc.

I/O ports 118 allow computing device 100 to be logically coupled to other devices including I/O components 120, some of which may be built in. Illustrative components include a microphone, joystick, game pad, satellite dish, scanner, printer, wireless device, keyboard, pen, voice input device, touch input device, touch-screen device, interactive display device, or a mouse. I/O components 120 can also include communication connections 121 that can facilitate communicatively connecting the computing device 100 to remote devices such as, for example, other computing devices, servers, routers, and the like.

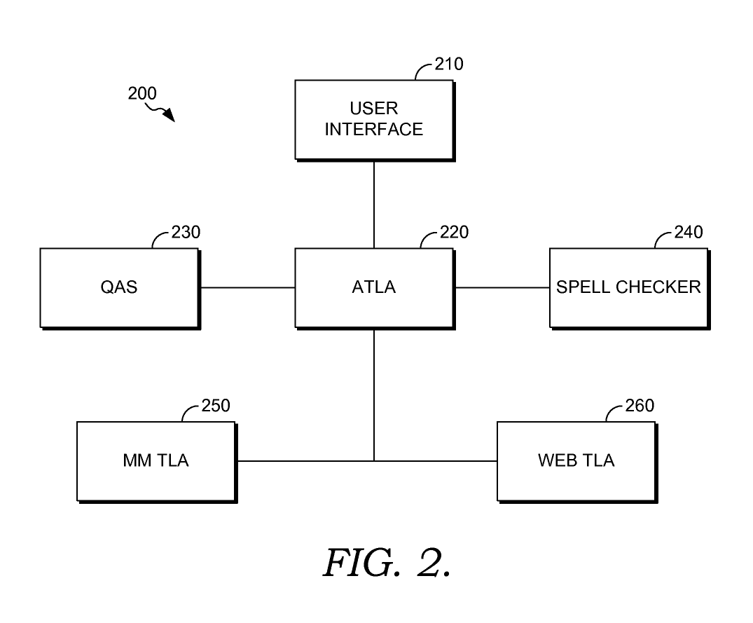

FIG. 2 is a schematic diagram 200 illustrating an exemplary system for determining search query intent based on search results retrieved in response to receiving a search query, in accordance with an embodiment of the present invention. In particular, FIG. 2 comprises user interface 210, answer top level aggregator 220, query answer service 230, spell checker 240, multimedia top level aggregator 250, and web top level aggregator 260. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

User interface 210 receives user input relating to a search query and safety threshold settings. In particular, a user may input search queries and safety threshold settings into a user interface 210 of a computing device, such as computing device 100. Additionally, once a search query has been processed, a page of results may be presented on user interface 210. Results responsive to a search query may be presented on user interface 210. Further, in the case where no valid search results are responsive to the search query entered in user interface 210, a blank page or a page with a generic search result may be presented on user interface 210.

Once a search query is entered at user interface 210, the search query may be provided to answer top-level aggregator 220. Answer top-level aggregator 220 may process the search query. In particular, answer top-level aggregator 220 may send the search query to spell checker 240 to modify the search query into a correct form. In particular, if the search query states “Christohper Columbus,” spell checker 240 may amend the search query to say, “Christopher Columbus.” The modified search query may then be returned to answer top-level aggregator 220.

Additionally, the search query may be provided to query answering service 230. At query answering service 230, the search query may be analyzed to determine if the search query is associated with adult content. The search query may be analyzed using an automated analysis to determine whether the user intends the search query to return adult content. This analysis of the search query may be independent of an analysis of search results returned in response to the search query. The result of the analysis may be indicated in a query-intent score. The query content score may indicate a yes/no classification verdict. The query content score may indicate a confidence, which ranges from high to low on a scale, that the intent of the query is to return adult content. In one embodiment, a classifier performs the automated analysis.

The search query may be compared against an adult black list and/or an adult white list, where a black list is a listing of queries that are definitely associated with adult content and the white list is a listing of queries that are definitely not associated with adult content. The black list and the white list evolve and, accordingly, the determination that a search query is on a black list or a white list is time-dependent based on when the search query was analyzed. The query answering service 230 generates the search-query intent score based on adult content in one or more of the results returned in response to the search query. Methods of calculating the search-query intent score are described in more detail subsequently. Once the search query has been analyzed at query answering service 230, the search query may be provided back to answer top-level aggregator 220.

Answer top-level aggregator 220 may provide the search query to multimedia top-level aggregator 250 and/or web top-level aggregator 260. At multimedia top-level aggregator 250, a plurality of search results having multimedia content may be provided in response to the search query. Further, each of the plurality of search results retrieved may have tags that indicate characteristics about the search results. Tags may be used to indicate adult content within a document. The tags may be used by multimedia top-level aggregator 250 to assign an adult-content score to each of the plurality of search results. Additionally, the plurality of search results may be ranked according to relevance by a ranker. In addition to the adult-content score, the ranking of each of the plurality of search results may be provided from multimedia top-level aggregator 250 to answer top-level aggregator 220. Alternatively, the ranking of each of the plurality of search results may be used in calculating adult-content scores for the plurality of search results.

Similarly, answer top-level aggregator 220 may provide the search query to web top-level aggregator 260. At web top-level aggregator 260, a plurality of search results having multimedia content may be provided in response to the search query. Further, each of the plurality of search results retrieved may have tags that indicate characteristics about the search results. Tags may be used to indicate adult content within a document. The tags may be used by web top-level aggregator 260 to assign an adult-content score to each of the plurality of search results. Additionally, the plurality of search results may be ranked by a ranker. In addition to the adult-content score, the ranking of each of the plurality of search results may be provided from web top-level aggregator 260 to answer top-level aggregator 220. Alternatively, the ranking of each of the plurality of search results may be used in calculating adult-content scores for the plurality of search results. Once answer top-level aggregator 220 has received the adult-content scores, answer top-level aggregator 220 may generate a search-query-intent score based on the adult-content scores of the plurality of search results. Alternatively, the search-query intent score may be based only on analysis of the search query without analyzing the plurality of search results.

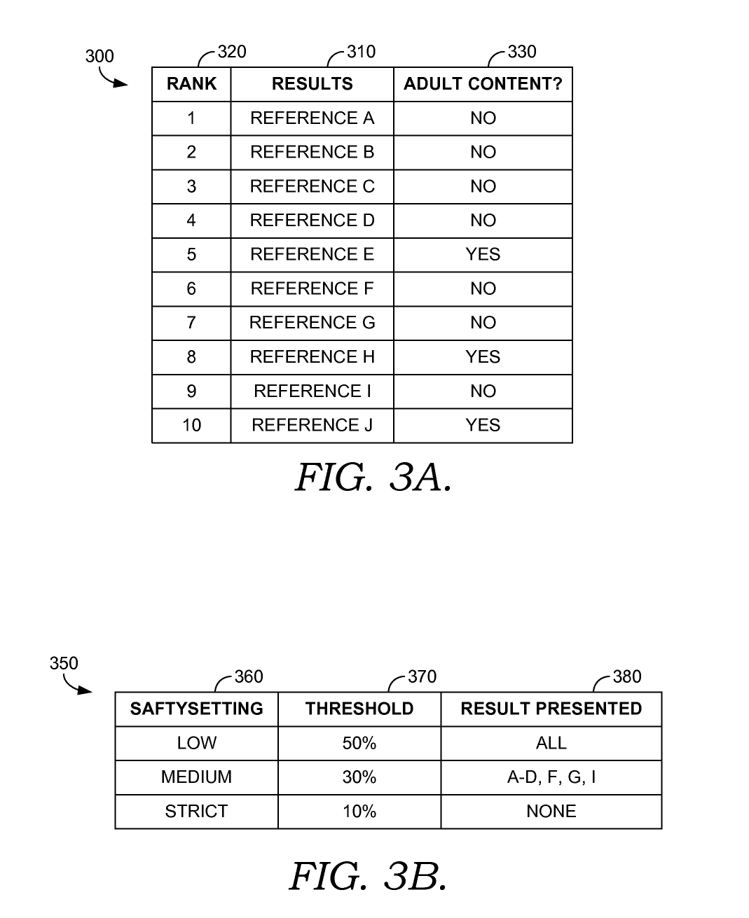

FIG. 3A is a schematic diagram 300 that illustrates an assessment of search results based on adult-content scores, in accordance with an embodiment of the present invention. Diagram 300 comprises references 310 that are retrieved in response to a search query. In particular, references 310 are referred to as references A-J and each have a relevance rank 320 assigned by a ranking component. Additionally, each of references 310 are assigned an identifier 330 that indicates whether each reference 310 is associated with adult content. As seen in FIG. 3A, references E, H, and J are associated with adult content. The rest of the references 310 are not associated with adult content. Based on diagram 300 of references A-J, a search-query-intent score may be assigned to the search query that was the basis for retrieving the search result references 310. The search-query-intent score may be based on safety settings that are associated with the search query intent.

FIG. 3B is a schematic diagram 350 that illustrates a determination of search results based on adult-content scores, in accordance with an embodiment of the present invention. In particular, FIG. 3B comprises safety settings 360, threshold 370 associated with each safety setting 360, and results presented 370. As seen in FIG. 3B, a low safety threshold results in a high adult-content score when 50% or more of the search results are associated with adult content. Similarly, a moderate safety threshold results in a high adult-content score when 30% or more of the search results are associated with adult content. Further, a strict safety threshold results in a high adult-content score when 10% or more of the search results are associated with adult content.

Additionally, FIG. 3B illustrates the search results presented to the user in response to each setting when 30% of the search results are associated with adult content. For example, a low setting results in all references A-H being presented to a user since the overall safety threshold at the low setting is 50%. A moderate setting results in references A-D, F, G, and I (i.e., the search results not associated with adult content) being presented to the user. Accordingly, under a moderate setting that meets the safety threshold of 30%, the search results associated with adult content are filtered out of the search results, but the search results not associated with adult content are still presented to the user. Further, a strict safety setting results in no search results being presented to the user because the overall search query exceeds the 10% safety threshold of the safety setting. As such, the moderate and strict safety settings may influence the presentation of results in different ways.

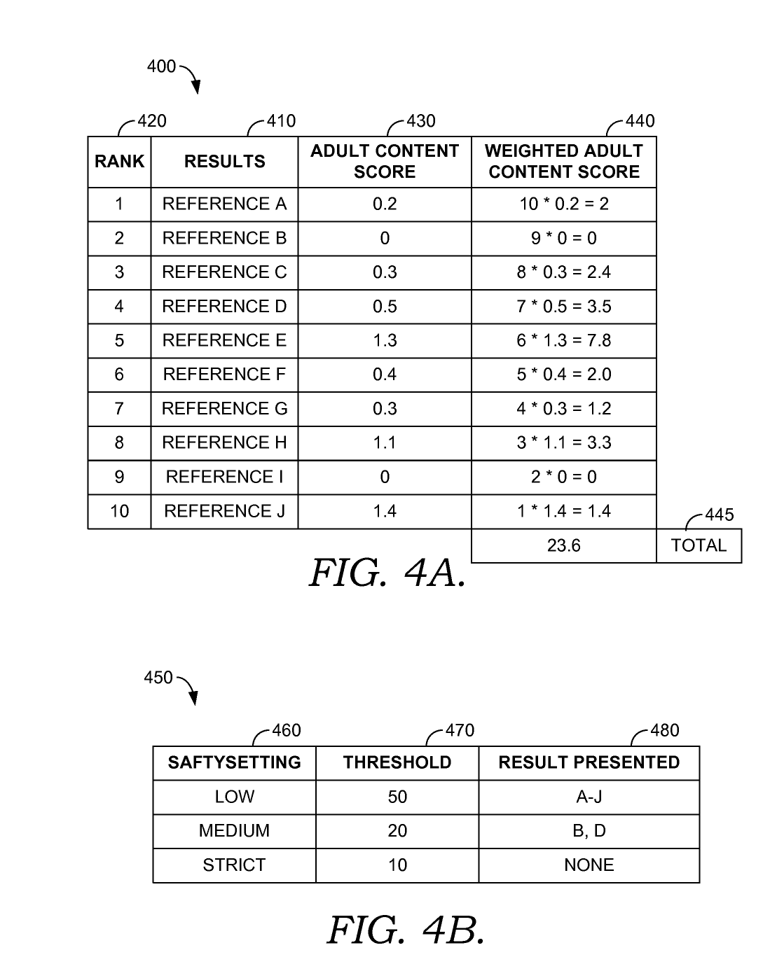

FIG. 4A is a schematic diagram 400 that illustrates an assessment of search results based on weighted adult-content scores 440, in accordance with an embodiment of the present invention. Diagram 400 comprises references 410 that are retrieved in response to a search query. In particular, references 410 are referred to as references A-J and each have a rank 420 assigned by a ranking component. Additionally, each of references 410 is assigned an identifier 430 that indicates whether each reference 410 is associated with adult content. As seen in FIG. 4A, references E, H, and J are associated with adult content above a threshold of adult-content score of 1.0. Further, weighted adult-content scores 440 are calculated based on the adult-content scores 430 and rank 420 of references 410. For example, the top-ranked reference, reference A, has an adult-content score 430 that is weighted by a factor of 10, and the lowest-ranked reference, reference J, has an adult-content score 430 that is weighted by a factor of 1. Embodiments of the present invention are not limited to the linear weighting factors illustrated. The weighting factors used may be non-linear, for example by using a logarithmic scale to generate weighting factors. Based on assessment of references A-J, a search-query-intent score may be assigned to the search query that was the basis for retrieving the search result references A-J. In particular, the search query-intent score may be the cumulative total 445 of weighted adult-content scores 440. As such, cumulative total 445 is equal to 23.6. Further, as seen in FIG. 4B, the search-query-intent score may be based on safety settings that are associated with the query intent.

FIG. 4B is a schematic diagram 450 that illustrates a determination of search results to be provided in response to a search query based on weighted adult-content scores, in accordance with an embodiment of the present invention. As seen in FIG. 4B, a low safety setting results in a high adult-content score when references A-J have a cumulative total 445 above 50. Similarly, a moderate safety setting results in a high adult-content score when references have a cumulative total 445 above 20. Further, a strict safety setting results in a high adult-content score when references have a cumulative total 445 above 10.

Additionally, FIG. 4B illustrates the search results presented to the user in response to each safety setting based on the weighted adult-content score threshold associated with each safety setting. For example, a low safety setting results in presenting all references A-J to a user since the search query threshold 470 has not been met for the low safety setting. Additionally, the moderate safety setting results in references B and D being presented to the user as the search query exceeds the safety threshold for the moderate setting, but references B and D have been assessed as having no adult content. Accordingly, references B and D may be presented as exceptions under the moderate safety setting. Further, a strict safety setting results in no references being presented to the user as the safety threshold for the strict setting has been met. In contrast to the moderate safety setting, where references may be presented if they meet an exception of having no adult content, the strict safety setting may not allow exceptions to be made.

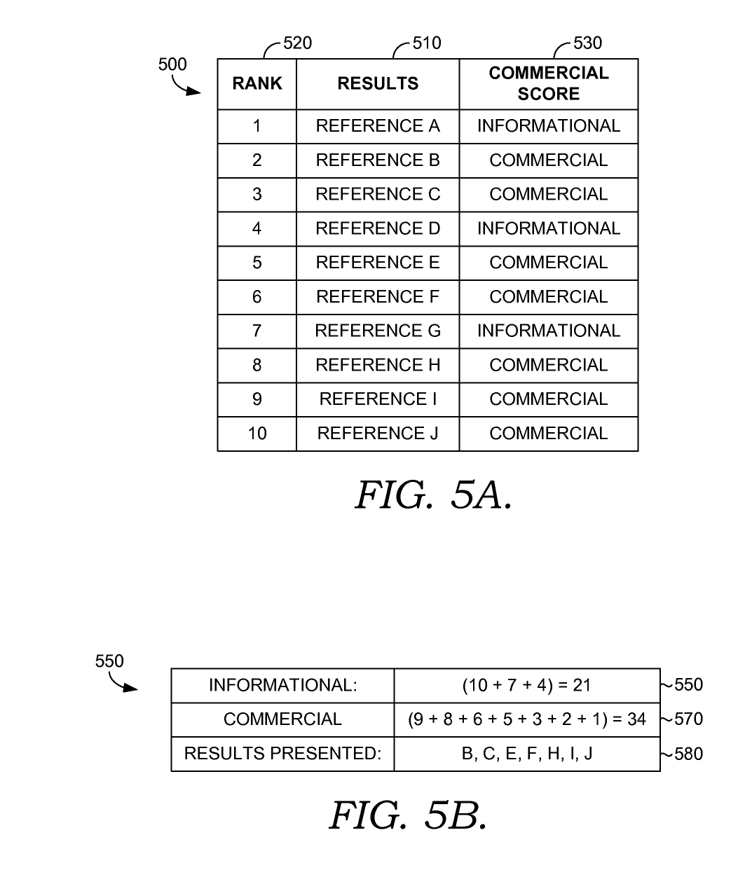

FIG. 5A is a schematic diagram 500 that illustrates an assessment of search results to be provided in response to a search query based on weighted commercial scores, in accordance with an embodiment of the present invention. In particular, diagram 500 comprises references 510, referred to as references A-J, having a category 530 labeling the references as commercial or informational. In one embodiment, a subject-matter classifier determines whether an individual reference is commercial or informational. Additionally, references A-J each have a rank 520 assigned by a ranking component on an integer scale from 1-10. As seen in FIG. 5A, references B, C, E, F, and H-J have a commercial category and references A, D, and G have an informational category.

FIG. 5B is a schematic diagram 550 that illustrates a determination of search results to be provided in response to a search query based on weighted commercial scores, in accordance with an embodiment of the present invention. In particular, a search-query-intent score for commercial intent is calculated by summing up the weighted commercial scores of references A-J. In this example, a weighted commercial score is generated for an individual reference by multiplying its rank by one, if it is commercial, or zero, if the reference is classified as informational. A similar method may be used to generate a weighted informational score for a reference. As seen in FIG. 5B, the search query has an informational search-query-intent score of 21 and a commercial search-query-intent score of 34. As the query has a higher commercial search-query-intent score, a determination is made that a user submitting the search query had an intent of retrieving the commercial category of references. Accordingly, the search result presented to the user may be filtered to present only the commercial category of references. As such, references B, C, E, F, and H-J may be presented to the user in response to the search query, as references B, C, E, F, and H-J are all categorized as commercial results. Alternatively, the listing of all the references may be reordered to prioritize the references associated with the determined search-query-intent. Accordingly, while all references may be presented to the user in response to the search request, references B, C, E, F, and H-J may be prioritized over references A, D, and G based on references B, C, E, F, and H-J being associated with the determined search query intent.

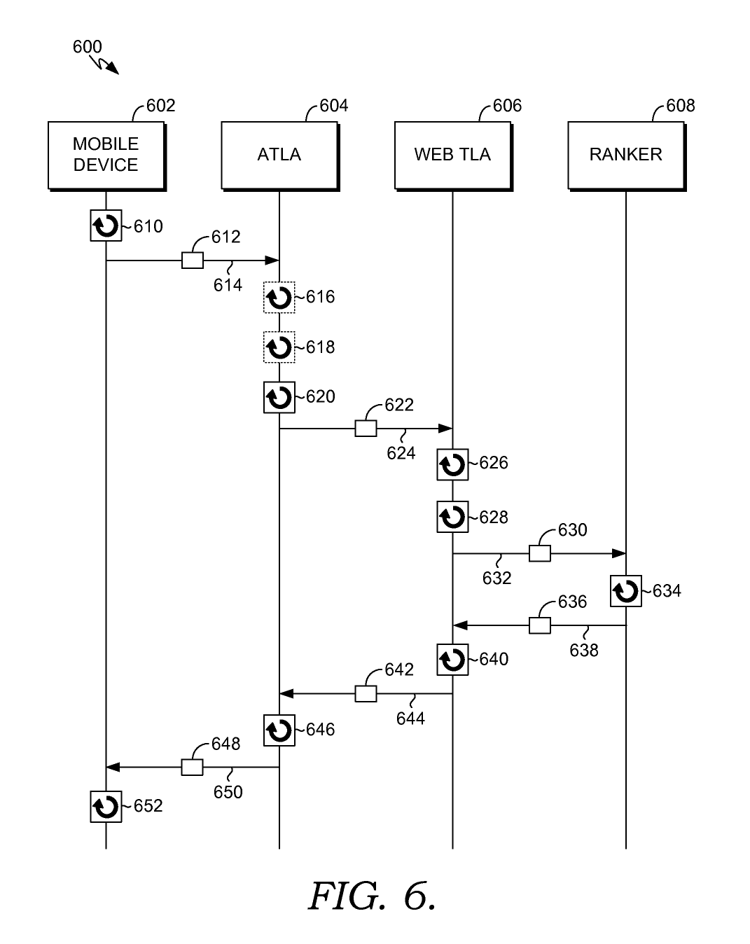

FIG. 6 is a process flow diagram 600 showing communications and steps that occur during an embodiment of a method of determining search query intent based on search results retrieved in response to receiving a search query, in accordance with an embodiment of the present invention. The method may selectively provide search results that are in accordance with a safety setting and responsive to a search query. Initially, a search query 612 is input 610 into an interface displayed on computing device 602. Computing device 602 may be similar to computing device 100 described previously with reference to FIG. 1. Search query 612 is provided 614 to an answer top-level aggregator (ATLA) 604. ATLA 604 may be similar to ATLA 220 described previously with reference to FIG. 2. Search query 612 may include a safety setting.

Once search query 612 is received at ATLA 604, ATLA may determine 616 an adult query classification of search query 612. Additionally or alternatively, ATLA 604 may modify 618 search query 612 based on a spell checker. Further, ATLA 604 may generate 620 a request 622 to provide search results responsive to search query 612. In particular, ATLA 604 may send 624 request 622 to Web top-level aggregator (Web TLA) 606. The Web TLA 606 may be similar to Web TLA 260 described previously with reference to FIG. 2. Request 622 may include a request for search results that are responsive to search query 612. Once request 622 is received at Web TLA 606, a plurality of search results that are responsive to the search query 612 may be determined 626. Further, a request 630 may be generated 628 at Web TLA 606. Request 630 may include the plurality of search results. Additionally, request 630 may be sent 632 to Ranker 608.

At Ranker 608, the plurality of search results within request 630 may be ranked based on relevance of each of the plurality of search results to the search query. Once the plurality of searched results have been ranked 634, ranked search results 636 may be sent 638 to Web TLA 606. At Web TLA 606, ranked search results 636 may be combined 640 with metadata associated with ranked search results 636. The metadata may be generated by an automated analysis of the documents and stored in an index in a manner that allows that metadata to be associated with individual documents. The metadata may be based on feedback or input from one or more people. Further, response 642 may be sent 644 to ATLA 604. Response 642 may include ranked search results 636 and the metadata associated with ranked search results 636. ATLA 604 may generate 646 modified search results 648 that contain no adult content. In particular, ATLA 604 may filter ranked search results 636 based on the metadata associated with ranked search results 636. Modified search results 648 may be sent 650 to computing device 602. At computing device 602, modified search results 648 may be presented 652 to a user.

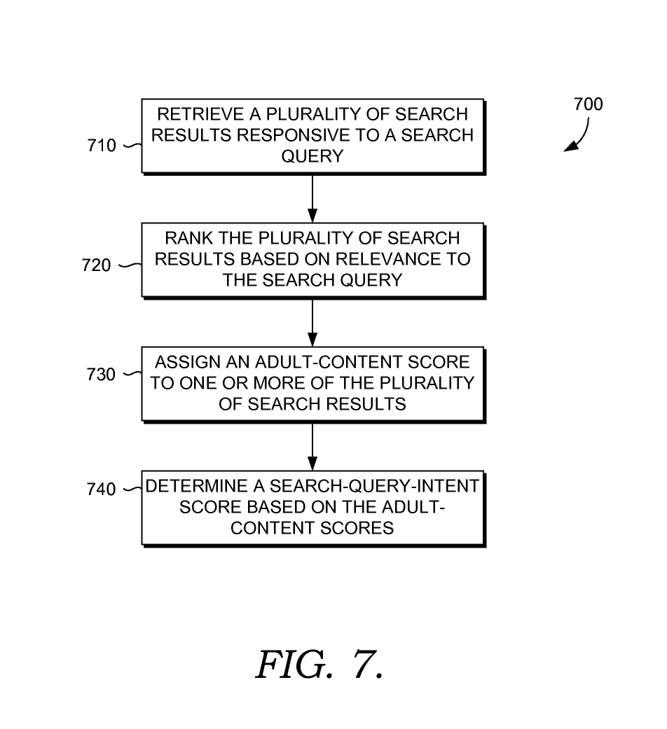

FIG. 7 is a flow diagram 700 illustrating a method of determining search intent based on search results retrieved in response to receiving a search query, in accordance with an embodiment of the present invention. At step 710, a plurality of search results that are responsive to a search query are retrieved. At step 720, the plurality of search results is based on relevance to the search query. At step 730, an adult-content score is assigned to one or more of the plurality of search results. In particular, the adult-content score is based on an amount of adult content within each of the one or more plurality of search results. For example, each adult-content score may be generated by a categorizer that uses a machine learning algorithm. At step 740, a search-query-intent score is determined based on the adult-content score of each of the one or more plurality of search results and the ranking of each of the one or more plurality of search results.

The determining a search-query-intent score may be based on weighting each adult-content score is based on weighting each adult-content score by a ranking of a correlating one or more plurality of search results. In particular, the weighting of each adult-content score may be based on a logarithmic function of the ranking of the correlating one or more plurality of search results. Alternatively, the weighting of each adult-content score may be based on a linear function of the ranking of the correlating one or more plurality of search results. Determining the search-query-intent score may also be based on weighting each adult-content score by a ranking of an individual search result to which an individual adult-content score is assigned. Further, the weighting of each adult-content score may be based on a logarithmic function of the ranking of the individual search result to which the individual adult-content score is assigned. Alternatively, the weighting of each adult-content score may be based on a linear function of the ranking of the individual search result to which the individual adult-content score is assigned.

Additionally, the method may further comprise determining the search-query-intent score fails to meet a safety threshold associated with the search query and presenting a page responsive to the search query. Further, the page may comprise no search results based on the determining the search-query-intent score fails to meet a safety threshold associated with the search query. Alternatively, the page may comprise a generic search result. In particular, the generic search result may be retrieved from a list of pre-approved search results.

Alternatively, the method may further comprise determining the search-query-intent score meets a safety threshold associated with the search query and presenting a page responsive to the search query. In particular, the page may comprise the plurality of search results. In further embodiments, the page may comprise each of the one or more plurality of search results that meet a safety threshold associated with individual search results.

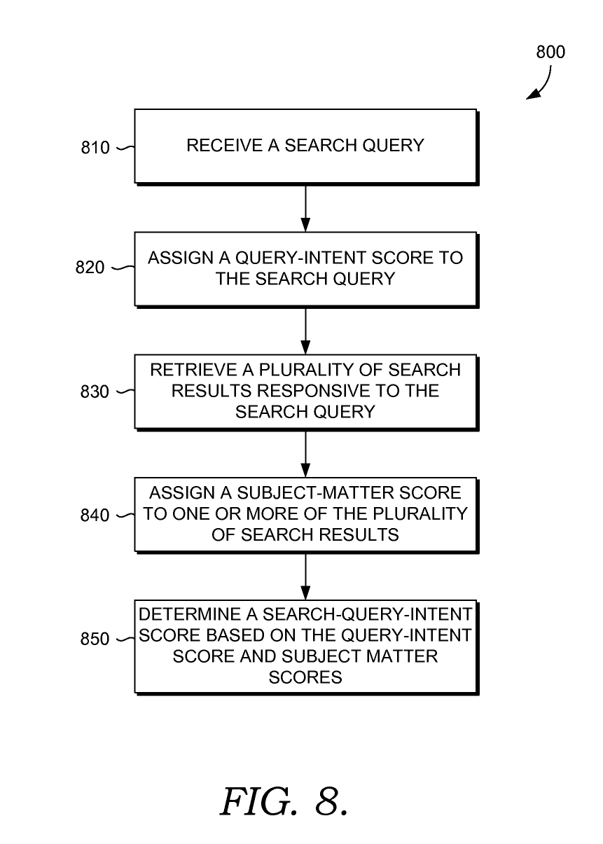

FIG. 8 is a flow diagram 800 illustrating a method of determining search intent based on search results retrieved in response to receiving a search query, in accordance with an embodiment of the present invention. At step 810, a search query is received. At step 820, a query-intent score is assigned to the search query. In particular, the query-intent score may be based on categorizing the search query according to intent to retrieve a document within a subject-matter category. For example, categorizing an amount of adult content within the search query may be based on keyword matching.

At step 830, a plurality of search results that are responsive to a search query are retrieved. At step 840, a subject-matter score is assigned to one or more of the plurality of search results. In particular, the subject-matter score may be based on content within each of the one or more plurality of search results that falls into the subject-matter category. For example, categorizing an amount of adult content within each of the one or more plurality of search results may be based on metadata associated with each of the one or more plurality of search results. Alternatively, categorizing an amount of adult content within each of the one or more plurality of search results may be based on a probability that adult content is within each of the one or more plurality of search results.

At step 850, a search-query-intent score is determined. The search-query intent score may be based on the query-intent score of the search query and the subject matter score of each of the one or more plurality of search results. Further, determining a search-query-intent score may be based on a safety threshold associated with the search query. For example, the safety threshold associated with the search query may be based on user preferences.

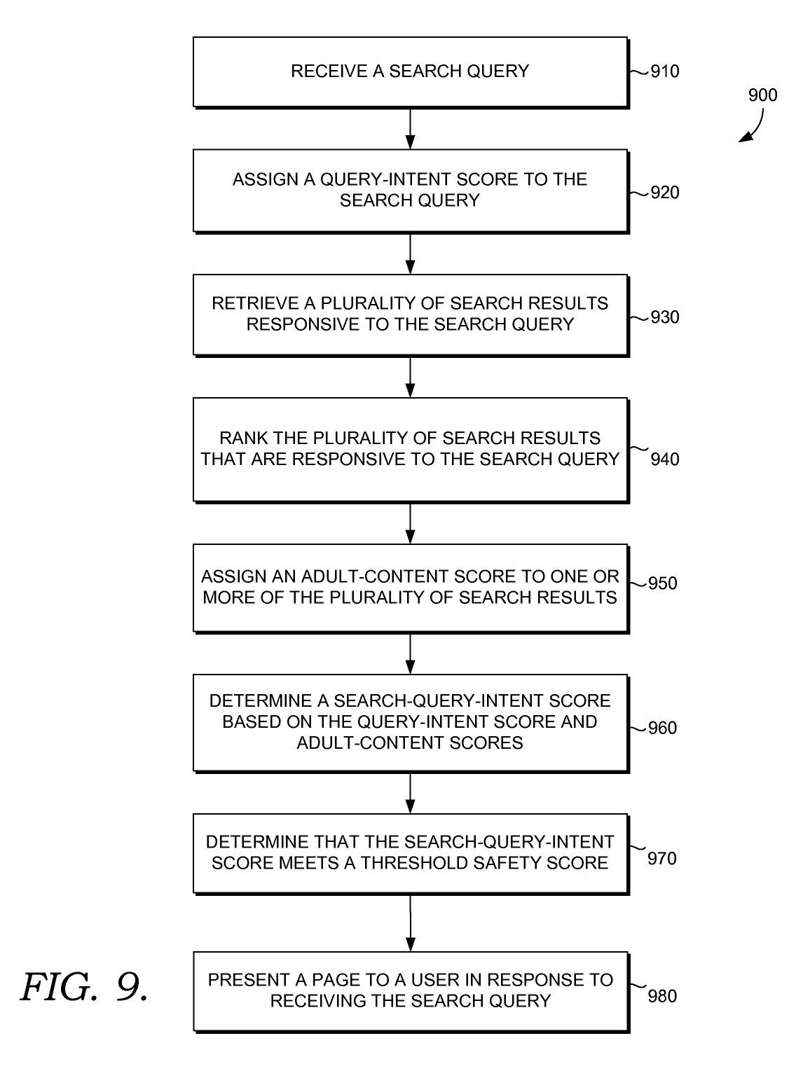

FIG. 9 is a flow diagram 900 illustrating a method of determining search intent based on search results retrieved in response to receiving a search query, in accordance with an embodiment of the present invention. At step 910, a search query is received. At step 920, a query-intent score is assigned to the search query based on an analysis of the search query that indicates whether the search query is intended to return results with adult content. At step 930, a plurality of search results that are responsive to a search query are retrieved.

At step 940, the plurality of search results is ranked based on relevance to the search query. At step 950, an adult-content score is assigned to one or more of the plurality of search results by categorizing each of the one or more plurality of search results based on characteristics that are consistent with adult content within each of the one or more plurality of search results. Additionally, at step 960, a search-query-intent score is determined based on the query-intent score of the search query, the adult-content score of each of the one or more plurality of search results, and the ranking of each of the one or more plurality of search results. At step 970, a determination is made that the search-query-intent score meets a threshold safety score. At step 980, a page is presented to a user in response to receiving the search query based on the search-query-intent score meeting the threshold safety score. For example, the page may comprise the plurality of search results.

Further, the method may comprise identifying a subset of the plurality of search results that have an adult-content score that fails to meet a threshold safety adult-content score. Additionally, the method may comprise modifying the plurality of search results to remove the subset of the plurality of search results. Additionally, the method may comprise presenting the modified plurality of search results on the page to the user.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. Computer-storage media having computer-executable instructions embodied thereon that, when executed, perform a method of determining search query intent based on search results retrieved in response to receiving a search query, the method comprising:
retrieving a plurality of search results that are responsive to a search query;
ranking the plurality of search results based on relevance to the search query;
assigning an adult-content score to one or more of the plurality of search results based on an amount of adult content within each of the one or more plurality of search results; and
determining a search-query-intent score based on the adult-content score of each of the one or more plurality of search results and the ranking of each of the one or more plurality of search results.

2. The computer-storage media of claim 1, wherein the determining the search-query-intent score is based on weighting each adult-content score by a ranking of an individual search result to which an individual adult-content score is assigned.

3. The computer-storage media of claim 2, wherein the weighting of each adult-content score is based on a logarithmic function of the ranking of the individual search result to which the individual adult-content score is assigned.

4. The computer-storage media of claim 2, wherein the weighting of each adult-content score is based on a linear function of the ranking of the individual search result to which the individual adult-content score is assigned.

5. The computer-storage media of claim 1, further comprising:
determining the search-query-intent score fails to meet a safety threshold associated with the search query; and
presenting a page responsive to the search query.

6. The computer-storage media of claim 5, wherein the page comprises no search results based on the determining the search-query-intent score fails to meet the safety threshold associated with the search query.

7. The computer-storage media of claim 5, wherein the page comprises a generic search result.

8. The computer-storage media of claim 7, wherein the generic search result is retrieved from a list of pre-approved search results.

9. The computer-storage media of claim 1, further comprising:
determining the search-query-intent score meets a safety threshold associated with the search query; and
presenting a page responsive to the search query.

10. The computer-storage media of claim 9, wherein the page comprises the plurality of search results.

11. The computer-storage media of claim 9, wherein the page comprises each of the one or more plurality of search results that meet the safety threshold associated with individual search results.

12. Computer-storage media having computer-executable instructions embodied thereon that, when executed, perform a method of determining search query intent based on search results retrieved in response to receiving a search query, the method comprising:
receiving a search query;
assigning a query-intent score to the search query based on categorizing the search query according to intent to retrieve a document within a subject matter category;
retrieving a plurality of search results that are responsive to the search query;
assigning a subject-matter score to one or more of the plurality of search results based on content within each of the one or more plurality of search results that falls into the subject matter category; and
determining a search-query-intent score based on the query-intent score of the search query and the subject-matter score of each of the one or more plurality of search results.

13. The computer-storage media of claim 12, wherein the categorizing the search query is based on keyword matching.

14. The computer-storage media of claim 12, wherein the categorizing an amount of adult content within each of the one or more plurality of search results is based on metadata associated with each of the one or more plurality of search results, wherein the metadata is generated based on analysis of the one or more plurality of search results.

15. The computer-storage media of claim 12, wherein the categorizing an amount of adult content within each of the one or more plurality of search results is based on a probability that adult content is within each of the one or more plurality of search results.

16. Computer-storage media having computer-executable instructions embodied thereon that, when executed, perform a method of determining search query intent based on search results retrieved in response to receiving a search query, the method comprising:
receiving a search query;
assigning a query-intent score to the search query based on an analysis of the search query that indicates whether the search query is intended to return results with adult content;
retrieving a plurality of search results that are responsive to a search query;
ranking the plurality of search results based on relevance to the search query;
assigning an adult-content score to one or more of the plurality of search results by categorizing each of the one or more plurality of search results based on characteristics that are consistent with adult content within said each of the one or more plurality of search results;
determining a search-query-intent score based on the query-intent score of the search query, the adult-content score of each of the one or more plurality of search results, and the ranking of each of the one or more plurality of search results;
determining that the search-query-intent score meets a threshold safety score; and
presenting a page to a user in response to receiving the search query based on the search-query-intent score meeting the threshold safety score.

17. The computer-readable media of claim 16, wherein the page comprises the plurality of search results.

18. The computer-storage media of claim 16, further comprising:
identifying a subset of the plurality of search results that have an adult-content score that fails to meet a threshold safety adult-content score;
modifying the plurality of search results to remove the subset of the plurality of search results; and
presenting the modified plurality of search results on the page to the user.

19. The computer-storage media of claim 16, wherein the determining the search-query-intent score is based on a safety threshold associated with the search query.

20. The computer-storage media of claim 19, wherein the safety threshold associated with the search query is based on user preferences.
